(19) United States
(12) Patent Application Publication
(10) Pub. No.: US 2010/0154232 A1
(43) Pub. Date: Jun. 24, 2010

(54) SCENTED HANDLE FOR USE IN A RAZOR

(75) Inventor: Kostas Reggis, Halandri-Athens (GR)

Correspondence Address: JONES DAY, 222 EAST 41ST ST, NEW YORK, NY, 10017, US

(73) Assignee: BIC-Violex SA, Anixi (GR)

(21) Appl. No.: 11/909,575

(22) PCT Filed: Mar. 23, 2005
(86) PCT No.: PCT/EP2005/003971

§ 371 Date: Sep. 24, 2007

(51) Int. Cl. B26B 21/52; B29C 45/14

(52) U.S. Cl. 30/526; 264/279; 264/246

(57) ABSTRACT

A process of making a razor handle including the steps of: providing at least one elastomeric material; providing a polymeric support having at least one fragrance; optionally providing at least one pigment; mixing the elastomeric material, the polymeric support and the pigment if provided; and forming at least one grip portion from the mixed elastomeric material and the polymeric support on the razor handle.

### CROSS-REFERENCE TO RELATED APPLICATION

This application is a national stage application of International Application No. PCT/EP2005/003971, filed on Mar. 23, 2005, the entire contents of which are incorporated herein by reference.

### BACKGROUND OF INVENTION

1. Field of Invention

Embodiments of the present invention relate to a handle for use in a razor. More particularly, embodiments of the present invention relate to a razor handle comprising a scented grip portion, and to a process for manufacturing the same.

2. Description of the Related Art

Razors and wet shaving devices are known in the art. Handles for use in such razors can comprise a rigid part and an elastomeric part, where the elastomeric part provides a grip portion that greatly facilitates the manipulation of the razor during shaving. Shaving is usually regarded as a cumbersome but necessary task. In order to make shaving a pleasant, enjoyable and fulfilling moment of the day, there is presently provided a scented razor handle, and a process for manufacturing same.

### SUMMARY OF THE INVENTION

In one embodiment, the present invention is directed to a process of making a razor handle. The process comprises the steps of:
a) providing at least one elastomeric material;
b) providing a polymeric support comprising at least one fragrance;
c) optionally providing at least one pigment;
d) mixing the elastomeric material and the polymeric support (and optionally, the pigment); and
e) injecting the resulting mixture to form at least one grip portion on the handle.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a front top perspective view of a razor, according to an embodiment of the present invention.

### DESCRIPTION

In the context of embodiments of the present invention, “elastomer” or “elastomeric compound” refers to any elastomer composition known in the art and is of any elastomeric hardness range, especially those suitable for making a grip portion of a razor, and those that are in the Shore A hardness range. This includes elastomers and thermoplastic elastomers, as well as blends thereof. Suitable elastomers include nitrile rubbers (NBR), styrene butadiene rubbers (SDR), ethylene-propylene terpolymers (EPDM), and (compatible) mixtures thereof. Examples of suitable thermoplastic elastomers include styrene block copolymers, e.g. styrene-butylene block copolymers (SBS), styrene-ethylene-butylene block copolymers (SEBS), thermoplastic polyurethanes, polyether block amides, copolyesters, thermoplastic polyolefins (EPDM/PP, NBR/PP, etc., and (compatible) blends thereof. Moreover, the elastomeric material may contain at least one additive.

Examples of additives include chemicals commonly classified as antioxidants, UV-stabilisers, adhesion modifiers, smell reducers and other such materials that are known to those skilled in the art, and that function to improve processing of the material, enhance its self-life and service durability, improve the adhesion to substrates that “polymeric supports” are not inherently inter-compatible with, and retard inherent sensory defects, such as the inherent typical smell of elastomers and elastomeric compounds.

In the context of embodiments of the present invention, “polymeric support” refers to any polymer-containing material that is suitable for the loading of at least one fragrance. The polymeric support can advantageously comprise a porous polymeric component. Examples thereof include porous olefins, such as, but limited to, porous polyethylene (e.g. low density polyethylene, LDPE; or very low density polyethylene, VLDPE); porous polypropylene, and other such polymeric materials that can be taken to a porous condition such as styrenics, amides, urethanes, vinyls and blends thereof. Advantageously, according to embodiments of the present invention, the polymeric support ensures proper loading of the fragrance, with a defined and reproducible loading rate. Moreover, the polymeric support advantageously allows the incorporation of the fragrance while allowing processing thereof under harsh temperature conditions because fragrances are usually very heat-sensitive and tend to be very easily degraded during processing operations such as molding. Moreover, according to embodiments of the present invention, advantageously, the fragrance is distributed throughout the elastomeric material in an optimal way.

In the context of embodiments of the present invention, “fragrance” or “scent” means any composition able to impart a scent perceived by a human being. This includes mixtures of aromatic synthetic raw materials (like Lyral) and others of natural origin, like natural oils (orange oil, citrus oil, lavender oil, lemon oil, etc.). The fragrance can be a more complex composition, comprising several scent-imparting compounds. The fragrance can be reminiscent of, for example, flowers (e.g. lavender, rose, magnolia, lily, etc.) and/or fruits (orange, citrus, apple, vanilla, etc.). In one embodiment of the present invention, the fragrance can be reminiscent of lavender. This fragrance advantageously conveys the feeling of freshness, cleanliness and purity, thus making shaving a unique experience for the senses and a perceived comfortable one for the user.

In the context of embodiments of the present invention, “pigment” refers to any composition comprising a dye or colorant that is suitable for processing according to embodiments of the present invention. The pigment can advantageously be selected to confer a colour matching the selected fragrance. For example, if the fragrance is lavender scented, it is possible to use a violet or purple pigment in order to confer a synergistic effect on the user: the visual impression created by the colour acts in combination with the scent, thus providing the user with a unique combination sensory experience. Alternatively, the pigment can also be used in another part of the handle, for example, in at least one rigid plastic portion of the handle.

Mixing and injection (injection molding) techniques are known in the art. For example, the mixing step can include tumble drying. Additionally, for example, the injection step can be carried out under conditions known in the art, for instance, at temperatures ranging 180-210° C. It is also possible to use co-injection techniques where the grip portion of the handle can be co-injected together with another part of the handle, for instance, a rigid portion of the handle. The skilled person would know how to set up such a process.

In the context of embodiments of the present invention, “grip portion” refers to any elastomeric element of the razor handle that is susceptible to be in contact with a user's hand during any shaving operation. The grip portion can be suitably designed in terms of shape and position on the handle, in order to facilitate the manipulation thereof, for any position or configuration of the razor with respect to any body part (beard, moustache, armpits, legs, etc.) during the shaving thereof. The grip portion can thus have various shapes and designs. For example, the grip portion can be integral with at least one rigid plastic portion of the handle. Alternatively, the grip portion can be in the shape of at least one bulky patch, in the shape of a plurality of patches, in the shape of a plurality of fins, or combinations thereof. The grip portion can also comprise a plurality of protrusions. The present invention encompasses the various designs thereof, as well as their location(s) on the handle.

The process of the present invention is advantageously easy to implement on standard equipment, and avoids degradation of the fragrance molecules during processing. Additional embodiments of the present invention are directed to razor handles obtainable by the processes as described herein.

The handle of the present invention also comprises at least one rigid plastic part in combination with the grip portion, as detailed above. The overall design of the handle is advantageously ergonomic, thereby facilitating manipulation by the user.

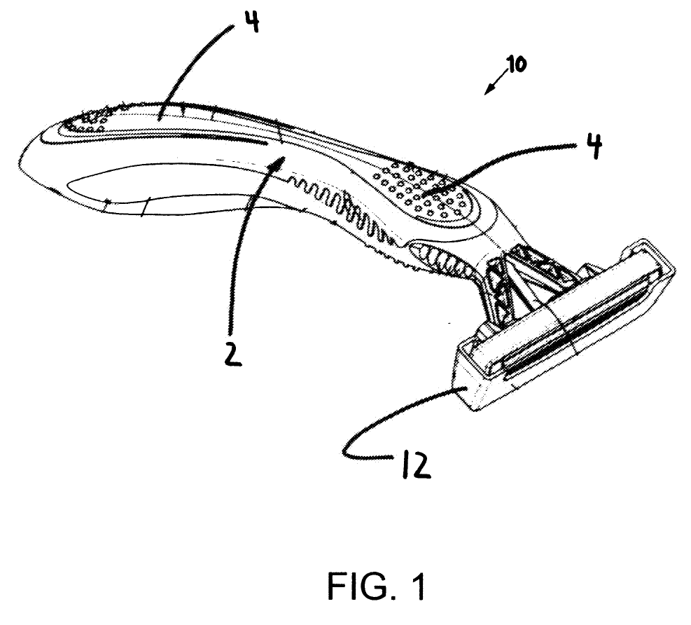

As depicted in FIG. 1, another embodiment of the present invention provides a razor handle 2 comprising at least one grip portion 4, wherein the grip portion 4 comprises at least one fragrance. According to embodiments of the present invention, the grip portion 4 can advantageously release the fragrance for a duration of at least two months, preferably at least three months, most preferably at least six months (upon storage under normal conditions). Moreover, because the fragrance is incorporated in the grip portion, it is less exposed to hot water than other parts of the razor, especially the head, which is repeatedly in contact with hot water during shaving and rinsing operations. The fragrance, which generally includes heat-sensitive molecules, is thus advantageously less exposed to hot water, and thus, has a longer life expectancy, providing an extra-sustained release of the fragrance and, accordingly, a lengthened duration of the scent.

The final concentration of the fragrance in the grip can be adjusted by those skilled in the art. The final concentration can be less than 1 k % (w/w-by weight). For example, the concentration can range from 0.1 to 0.9%, more particularly from 0.25% to 0.9%, e.g. 0.3, 0.4, . . . , 0.7, 0.8, 0.9%.

In another aspect, as depicted in FIG. 1, embodiments of the present invention are also directed to a razor 10, especially a wet razor, comprising a handle 2 as described herein. The razor 10 is generally assembled by mounting a shaving head 12 onto the handle 2. The shaving head 12 generally comprises a platform, and at least one blade. The platform can advantageously comprise two, three, or more blades, optionally a guard bar (front bar, especially a rubber front bar), and optionally a shaving aid. The razor 10 can be for use by a male and/or a female.

The advantages of the handles, razors and processes according to the invention will become apparent from the following examples, which are given below as mere illustrations, and are non limitative.

### EXAMPLES

A razor handle according to an embodiment of the present invention can be manufactured as follows. A porous olefin support (micro-porous low density polyethylene pellets, Accurel® MP300, Membrana) is loaded via an established process and known to those skilled in the art, with a lavender fragrance (Lavender desire 25704/01, Vioryl) at room temperature, to yield an impregnated polymeric sponge (60% fragrance, 40% polymeric porous support). The resulting pellets of the impregnated polymeric sponge are then mixed with a colour concentrate (Neolen White 1959, D. Souris), which comprises 70% pigment (white) and 30% polymeric carrier (polyethylene). The mix ratio can be 3.5 kg of colour concentrate to 0.6 kg of lavender-impregnated polymeric sponge. The mixing is performed in a 50 L Loedige FM-50E batch mixer at low speed for 5 minutes. The resulting mixture contains 14.63% of impregnated polymeric sponge and 85.37% of Neolen White 1959. This mixture (4.1 kg) is then mixed (tumble drying) with an elastomer (50 kg) (styreneethylene-butylene copolyrner/styrene butadiene copolymer, Bergaflex, Polyone).

The final concentration of the fragrance is 0.66% in the final product, which is co-injected in a molding machine at temperatures ranging between 180° C. and 210° C. onto the rigid plastic part of the handle, which, in this instance, is made of a transparent ABS material, such as, for example, Starex from Samsung. The resulting handle is then assembled with a razor head comprising 3 blades, a front bar, and a shaving aid.

The grip portion (elastomeric part) advantageously dispenses a very pleasant lavender scent, with a durability of at least six months. Tests were performed with the packaged shavers in their saleable blisters (that are not air-tight). These blisters were placed in environmental chambers at 55° C. and concurrently 45% RH (relative humidity) for a period of 14 days. At the conclusion of this test, upon opening the blisters and allowing for settlement of odor, it was evidenced by the test operators that the individual handles still retained the pleasant lavender scent. Without being bound by theory, it is postulated that for temperature accelerated processes (such as release of scent), an Arrhenius type equation can approximate them. It is further postulated that for every ten degree reduction in temperature, an analogous decade effect in time can be anticipated. For example, at 45° C. (a ten degree reduction from the test temperature) a similar behavior may have been anticipated after 20 weeks (a decade increase in time duration). There are several parameters that influence this postulation that are beyond the scope of this application and hence, the claim that the durability is at least six months under conditions of normal storage.

The same process may be repeated to provide handles with different fragrances or scents, for example, other floral scents, such as rose (Rose plast 25700/12, Vioryl), a fruit scent, such as orange (Orangina plast 3797/12, Vioryl) and a musky scent (Escape can 23697/12, Vioryl).

For each of these handles, the duration of the scent release is at least six months upon storage.

A panel of users (male and female) tests the handles and razors, and finds very satisfactory both the released scent and the duration thereof.

1-9. (canceled)

10. A process of making a razor handle, comprising the steps of:
a) providing at least one elastomeric material;
b) providing a polymeric support comprising at least one fragrance;
c) optionally providing at least one pigment;
d) mixing the elastomeric material, the polymeric support and the pigment if provided; and
e) forming at least one grip portion from the mixed elastomeric material and the polymeric support on the razor handle.

11. The process according to claim 10, wherein the elastomeric material is a styrene block copolymer.

12. The process according to claim 11, wherein the styrene block copolymer is selected from the group consisting of styrene-ethylenebutylene, styrene-butadiene, and blends thereof.

13. The process according to claim 10, wherein the polymeric support comprises a porous support.

14. The process according to claim 13, wherein the porous support is a porous olefin.

15. The process according to claim 10, wherein the at least one fragrance is selected from the group consisting of floral fragrances, fruit fragrances, and mixtures thereof

16. The process according to claim 10, wherein the mixing step includes tumble drying.

17. A razor handle made according to the process of claim 10.

18. A razor handle comprising at least one grip portion, wherein the grip portion comprises at least one fragrance.

19. The razor handle according to claim 18, wherein the grip portion releases the fragrance for a for at least two months.

20. A method of manufacturing a razor handle comprising the steps of:
providing an elastomeric material;
providing a polymeric support;
loading the polymeric support with at least one fragrance;
mixing the elastomeric material and the loaded polymeric support; and
injecting the mixed loaded polymeric support and the at least one pigment into a mold to form a gripping portion of the razor handle.

21. The method according to claim 20, further comprising the step of providing at least one pigment.

22. The method according to claim 21, wherein the at least one pigment is mixed with the elastomeric material and the loaded polymeric support and then injected into a mold to form a gripping portion of the razor handle.

23. A razor handle comprising:
at least one rigid plastic part; and
at least one gripping portion having at least one fragrance.

24. The razor handle according to claim 23, wherein the at least one gripping portion comprises an elastomeric material and a polymeric support.

25. The razor handle according to claim 24, wherein the polymeric support is loaded with the at least one fragrance.

26. The razor handle according to claim 24, wherein the elastomeric material is a styrene block copolymer.

27. The razor handle according to claim 26, wherein the styrene block copolymer is selected from the group consisting of styrene-ethylenebutylene, styrene-butadiene, and blends thereof.

28. The razor handle according to claim 24, wherein the polymeric support is a porous support.

29. The razor handle according to claim 28, wherein the porous support is a porous olefin.

30. The razor handle according to claim 23, wherein the at least one fragrance is selected from the group consisting of floral fragrances, fruit fragrances, and mixtures thereof.
